(19) United States
(12) Patent Application Publication
(10) Pub. No.: US 2026/0303460 A1
(43) Pub. Date: Oct. 1, 2026

(54) SYSTEMS AND METHODS FOR REDUCING INTERNET TRAFFIC LATENCY

(71) Applicant: Adeia Guides Inc., San Jose, CA (US)

(72) Inventor: Dhananjay Lal, Englewood, CO (US)

(21) Appl. No.: 19/095,543

(22) Filed: Mar. 31, 2025

(51) Int. Cl. H04L 41/0894; H04L 41/0823; H04L 43/0852

(52) U.S. Cl. CPC H04L 41/0894; H04L 41/0823; H04L 43/0852

(57) ABSTRACT

Systems and methods are provided for reducing or otherwise managing Internet traffic latency. In an illustrative example, data from a transmitting server is received at an access network server, and a data type associated with the data is identified at the access network server. It may be determined at the access network server that the data type is associated with low latency, and a separation distance associated with the access network server and the transmitting server may also be determined at the access network server. In this example, it is determined that the separation distance is greater than a distance threshold, and a low-latency policy is applied to the data. The data is transmitted from the access network server to a computing device in accordance with the low-latency policy.

One or more disclosed embodiments are directed towards systems and methods for reducing or otherwise managing Internet traffic latency. Some embodiments or aspects relate to additional or alternative features, functionalities, and/or fields.

### SUMMARY

With the widespread availability of fast and stable Internet connections, many people stream media, such as television programs, via the Internet; however, delivering media to computing devices, such as smart televisions, via the Internet is a bandwidth-intensive process. A factor that influences a user's experience with streamed media is the rebuffering rate. Rebuffering is when media, such as a streamed television program, stalls during playback and a user must wait for the media to resume playing on a computing device, such as a smart television. Rebuffering rates are a measurement of the percentage of the time media is loading versus the time it is playing.

Rebuffering may occur due to the transport layer connection utilized to transfer streamed media from a server to a client computing device that is being used to output the streamed media as opposed to the application layer (adaptive bitrate (ABR) client and/or player and server). When the path of traffic from the server to client computing device is longer, then the packets transferring the streamed media over the Internet may encounter greater latency as opposed to a shorter traffic path. A second order effect of greater path latency is higher jitter. High jitter results in a higher probability of out-of-order delivery of the packets, which may have a deleterious effect on a transport layer protocol such as transmission control protocol (TCP) by, for example, reducing throughput at the server. Quick user datagram protocol Internet Connection (QUIC) improves on TCP by enabling multiple streams within the same connection; however, QUIC may only alleviate the jitter issues rather than eliminating them entirely.

Internet traffic, while increasingly being deployed for shorter distances with edge computing, still remains largely long-haul. As such, there is a need for reducing media rebuffering rates when being streamed over the Internet, in particularly when media is streamed over long-haul connections between a server and a receiving computing device, such as a smart television.

To help address these problems, systems and methods are provided for reducing Internet traffic latency.

In accordance with an aspect of the disclosure, a method is provided that includes receiving data from a transmitting server and identifying a data type associated with the data at an access network server. It is determined that the data type is associated with prioritized treatment or application of a low-latency service, policy, or delivery, and based on, at least in part, the determining that the data type is associated with low latency, a separation distance associated with the access network server and the transmitting server is determined at the access network server. It is determined that the separation distance is greater than a distance threshold, and a low-latency policy is applied to the data. The data is transmitted, from the access network server, to a computing device in accordance with the low-latency policy.

In an illustrative system, an Internet service provider (ISP) access network in New York receives video traffic from a transmitting server physically located in Jacksonville. At the access network, it is identified (for example, via a trained machine learning model) that the Internet traffic is of the type live video. An access network server, for example, utilizes a look-up table to determine that live video traffic is associated with low latency. The live video traffic may be associated with low latency due to, for example, quality of experience considerations. In response to determining that the video traffic is associated with low latency, the access network server, for example, uses an Internet protocol (IP) geolocation database to determine that the transmitting server is physically located in Jacksonville. The access network server also determines that the distance between New York and Jacksonville is greater than a threshold distance. As the video traffic is identified as being associated with low latency and because the transmitting server is a distance away that is greater than the threshold distance, a low-latency policy is applied to the video traffic at the access network. The access network transmits the video traffic to a client computing device at a subscriber household, for example, a smart television, in accordance with the low-latency policy such that the video traffic is prioritized over other traffic in the access network.

### BRIEF DESCRIPTIONS OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

The above and other objects and advantages of the disclosure may be apparent upon consideration of the following detailed description, taken in conjunction with the accompanying drawings, in which:

FIG. 1 shows a schematic diagram for reducing Internet traffic latency, in accordance with some embodiments of the disclosure;

FIG. 2 shows another schematic diagram for reducing Internet traffic latency, in accordance with some embodiments of the disclosure;

FIG. 3 shows a flowchart for reducing Internet traffic latency, in accordance with some embodiments of the disclosure;

FIG. 4 shows a schematic graph indicating the impact of latency on Internet traffic;

FIG. 5 shows another schematic graph indicating the impact of latency on Internet traffic;

FIG. 6 shows another flowchart for reducing Internet traffic latency, in accordance with some embodiments of the disclosure;

FIG. 7 shows another schematic graph indicating the impact of latency on Internet traffic;

FIG. 8 shows another flowchart for reducing Internet traffic latency, in accordance with some embodiments of the disclosure;

FIG. 9 shows a flowchart of illustrative steps for reducing Internet traffic latency, in accordance with some embodiments of the disclosure;

FIG. 10 shows another flowchart of illustrative steps for reducing Internet traffic latency, in accordance with some embodiments of the disclosure;

FIG. 11 shows another flowchart of illustrative steps for reducing Internet traffic latency, in accordance with some embodiments of the disclosure; and

FIG. 12 shows a block diagram representing components of a computing device and dataflow therebetween for reducing Internet traffic latency, in accordance with some embodiments of the disclosure.

### DETAILED DESCRIPTION

Internet traffic includes any data that is transmitted from one computer to another via the Internet. It includes Internet traffic relating to gaming, voice over Internet protocol (VOIP), video streaming, interactive chat, television guides, web browsing and/or file downloading.

An access network includes a physical network that an ISP uses to deliver Internet traffic to subscribers of the ISP. The access network typically connects an ISP subscriber to a router, such as an edge router, of the Internet.

A data type includes a category of data such as gaming, video, chat, voice, and/or browsing. The data type may also relate to a specific application such as an Epic game launcher, a Netflix application, a Zoom video conferencing application, and/or a Chrome web browser. In some examples, the data type may be determined via examining an explicit congestion network (ECN) bit in a packet header of the data. In other examples, the data type may be determined via a trained machine learning model and/or a trained artificial intelligence model that examines the properties of the specific traffic flow (for example, packet sizes and/or packet interarrival times), and/or uses deep packet inspection.

Determining that a data type is associated with a high priority and/or low latency may comprise determining that the data type is associated with a low-latency service flow. Applying a high-priority and/or a low-latency policy to data may comprise transmitting that traffic in a preferential manner in an access network. In another example, applying the high-priority and/or low-latency policy to data may comprise transmitting that data via a low-latency service flow rather than a classic, default, and/or regular service flow. In some examples, some internet traffic a particular data type may be assigned to a low queuing latency, low loss and scalable throughput (L4S) regime, whereas internet traffic of a different data type may not be assigned to the L4S regime.

A separation distance may be a physical distance between a server and a client computing device, such as a smart television in an ISP subscriber household. A separation distance may be a straight-line distance between the server and the client computing device obtained from a querying a database. In another example, the separation distance may be a distance that takes into account Internet architecture, such as the length of fiber cables connecting routers and servers. In some examples, the separation distance may be a count or other representation of the number of intervening servers and/or nodes. In other examples, a separation distance may be based on a time it typically takes for Internet traffic to travel from a server to an ISP client computing device. A physical location of a server may be determined via, for example, metadata associated with Internet traffic and/or via an IP geolocation service.

The disclosed methods and systems may be implemented on one or more devices, such as user or client devices, servers, network management or other network devices, and/or other computing devices. As referred to herein, the device can be any device comprising a processor and memory, for example, a handheld computer, a mobile telephone, a portable video player, a portable music player, a portable gaming machine, a smartphone, a smartwatch, a smart speaker, an augmented reality headset, a mixed reality device, a virtual reality device, a gaming console, a vehicle infotainment headend or any other computing equipment, a wireless device, a modem, a router, a gateway, a repeater, a hub, a bridge, a network access point device, and/or combination of the same. Typically, a computing device will also comprise a network interface.

The methods and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory, including, but not limited to, volatile and non-volatile computer memory or storage devices such as a hard disk, USB drive, DVD, CD, media cards, register memory, processor caches, random access memory (RAM) and/or a solid-state drive.

In some examples, long-haul Internet traffic is detected, and the long-haul traffic is placed on a low-latency queue at an access network. For example, video traffic that originates from a distant data center is placed in a low-latency queue of an access network. This enables, for example, a reduction in latency and an improvement in jitter distribution. It may also enable the long-haul traffic to be delivered in real time from a distant location by circumventing a critical network bottleneck at the access network. In this manner, long-haul video traffic may be delivered with the same, or similar, benefits as real-time delivery from a network edge by utilizing a prioritization and/or treatment mechanism implemented within the ISP access network.

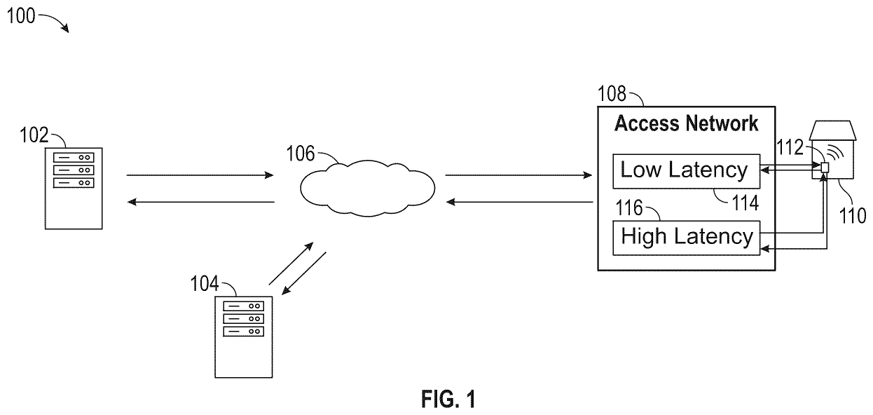

FIG. 1 shows a schematic diagram for reducing Internet traffic latency, in accordance with some embodiments of the disclosure. The environment 100 comprises a first server 102, a second server 104, a network 106, an access network 108, a physical location or endpoint 110, and a computing device 112. The first and second servers 102, 104 transmit and receive Internet traffic from the computing device 112. This Internet traffic includes Internet traffic with low latency requirements including, for example, gaming, VOIP and/or video streaming. The Internet traffic also includes Internet traffic that is not as sensitive to latency including, for example, web browsing and/or file downloading. The Internet traffic is transmitted to and from the servers 102, 104 to the computing device 112 via network 106, such as the Internet, and the access network 108. The computing device 112 may be any suitable computing device including, for example, a PC, a smartphone, a tablet, a smart television, an extended reality device, and/or a wearable device. The receiving computing device 112 may be connected to the access network 108 via a modem and/or a router. At the access network 108, a traffic policy is applied to the Internet traffic. In this example, the Internet traffic has a low-latency policy 114, or optionally, a high-latency policy 116 applied to it. The priority applied to the Internet traffic may be based on a distance of the server 102, 104 from the access network 108 and a type of the Internet traffic. In this example, the first server 102 is a relatively long distance away from the access network 108, so traffic from the first server 102 that is identified as being, for example, gaming, VOIP and/or video streaming traffic, has the low-latency policy 114 applied to it. In this example, the second server 104 is a relatively close distance to the access network 108, and the traffic is identified as being web browsing traffic, so the low-latency policy 114 is not applied to it. In this example, the high-latency policy 116 may be applied to traffic from the second server 104 to the computing device 112. In another example, no policy may be applied to traffic from the second server 104; however, applicable traffic from the first server 102 may be prioritized with respect to traffic from the second server 104. In this manner, Internet traffic latency may be reduced selectively and dynamically for certain traffic flows.

In some examples, a new class of applications is created that benefit from low latency and/or jitter, depending on conditions such as, for example, when traffic associated with an application of the class originates from a faraway or distant data center or server. In other examples, the methods and systems described herein may benefit live video delivery from distant locations (for example, live sports streaming of a soccer game in France to consumers in the United States). The methods and systems described herein may also be beneficial to transport delivery architectures, such as Media Over QUIC Transport (MoQT), that integrate contribution, distribution and consumption.

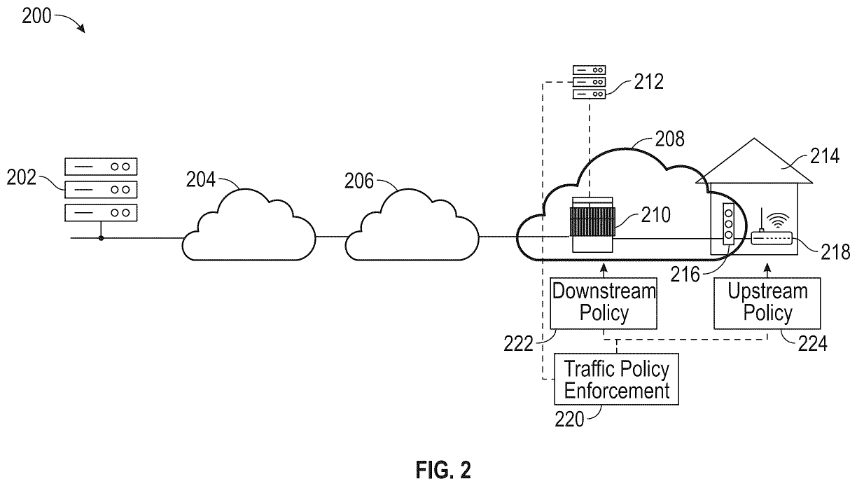

FIG. 2 shows another schematic diagram for reducing Internet traffic latency, in accordance with some embodiments of the disclosure. The environment 200 comprises a server 202, a carrier network 204, service provider network 206, an access network 208, a cable modem termination system (CMTS) 210, a traffic flow identification module 212, a physical location or endpoint 214, a cable modem 216 and a router 218. Internet traffic is transmitted from the server 202, such as a cloud server (including, for example, an HTTP adaptive streaming server) via the carrier network 204, the service provider network 206, the access network 208, and the cable modem 216 to the router 218, such as a home Wi-Fi router, where the Internet traffic is transmitted to one or more connected computing devices including, for example, a PC, a smartphone, a tablet, a smart television, an extended reality device and/or a wearable device. The service provider network 206 may comprise a core, regional and/or a metropolitan area service provider network, or networks. The traffic flow identification module 212 identifies a type of the traffic being transmitted via the access network 208 and enforces a traffic policy 220 including, for example, a downstream policy 222 and an upstream policy 224. The downstream policy 222 may, for example, prioritize video traffic, and the upstream policy 224 may, for example, prioritize interactive guide and/or chat traffic.

FIG. 2 illustrates an example system architecture for implementation in a cable broadband network. The traffic flow identification module 212 may perform an analysis to identify and isolate a type of traffic and/or application class for a flow. The traffic flow identification module 212 may subsequently make a determination whether the traffic is long-haul or short-haul. The traffic flow identification module 212 typically lies at the upstream edge the access network where it analyzes the upstream and downstream traffic flows for each ISP subscriber (or user) connected to the access network via a cable modem 216. Long-haul traffic may pass through multiple carrier networks, traversing interconnect and/or peering points in fiber hotels, until it reaches the ISP network and the ISP access network. Once a beneficiary flow (e.g., a long-haul traffic flow) is identified, policy enforcement is applied in the downstream (at the CMTS 210) or in the upstream (at the cable modem 216). While FIG. 2 is directed to a cable broadband network, a similar architecture may also be developed for mobile and/or satellite networks, where the traffic flow identification may also lie at the upstream edge of the respective access networks. For example, a traffic flow module may lie at an evolved nodeB (eNB) and/or a next generation nodeB (gNB) in a mobile network. The traffic flow module may further direct the IP packets of the identified flow for treatment to a low latency service flow and/or dedicated quality of service (QOS) flow.

The traffic flow identification module 212 may be responsible for analyzing ingress (and/or egress) Internet traffic at a home and/or subscriber level in order to classify Internet traffic flows into different categories and/or types to enable some of them to be prioritized and/or treated. In some examples, a hybrid traffic classification method based on machine learning may be utilized to classify Internet traffic. In some examples, the machine learning may utilize a packet multi-layer perception (P-MLP) model and/or majority voting method to classify encrypted traffic in the network. In other examples, deep packet inspection (DPI) products and/or approaches may be utilized for packet classification.

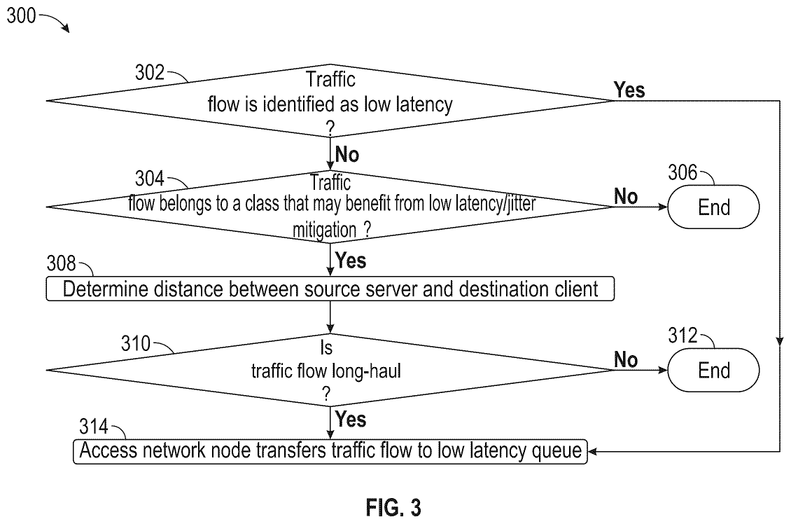

FIG. 3 shows a flowchart for reducing Internet traffic latency, in accordance with some embodiments of the disclosure. Process 300 may be implemented, in whole or in part, on any one or more of the computing devices mentioned herein. In addition, one or more actions of the process 300 may be incorporated into or combined with one or more actions of any other processes or embodiments and/or examples described herein.

At 302, a traffic flow is identified as low latency. For example, traffic flow may be identified as low latency using differentiated services (DiffServ) marking; examples of low latency traffic include gaming traffic and/or VOIP traffic. Traffic flow identification may be performed to isolate traffic at the flow level that is not explicitly marked for prioritization, but may benefit from the treatment under certain conditions, such as when it is long-haul. If, at 302, the traffic is identified as low latency then the process proceeds to step 314. If, at 302, the traffic flow is not identified as low latency, then the process proceeds to step 304. At 304, it is determined whether the traffic flow belongs to a class that may benefit from low latency and/or jitter mitigation. For example, traffic flow belonging to a class that may benefit from low latency and/or jitter mitigation includes streaming video, chat and/or interactive television guide traffic. If, at 304, it is identified that the traffic flow does not belong to a class that may benefit from low latency and/or jitter mitigation, then the process proceeds to step 306, where the process ends and the traffic continues to be transferred in a default manner, for example, in a low priority, non-low latency and/or as otherwise specified. If, at 304, it is identified that the traffic flow does belong to a class that may benefit from low latency and/or jitter mitigation, then the process proceeds to step 308.

At 308, a distance between a server, such as a source server, and a client computing device, such as a smart television, is determined. This determination may be performed via at least one of, for example, historical record lookup of the server, geolocation of the server, metadata associated with the Internet traffic, pinging the server, performing a traceroute to the server, determining a time-to-live (TTL) to the server, and/or performing a difference analysis to the server. This determination may be a coarse determination of the distance between the server and the client computing device. At 310, it is determined whether the traffic flow is long-haul based on the outcome of the determination of the distance. In some examples, a certainty associated with the determination of the distance is generated, and step 310 may also comprise determining whether the certainty is at or above a threshold certainty. In other examples, the traffic may be identified as long-haul or short-haul. If it is determined, at step 310, that the traffic flow is not long-haul, then the process proceeds to step 312, where the process ends and the traffic continues to be transferred in a default manner, for example, in a low priority, non-low latency, and/or as otherwise specified. If it is determined, at step 310, that the traffic flow is long-haul, then the process proceeds to step 314, where an access network node transfers traffic flow to a low-latency queue (or flow) and/or a dedicated QoS flow.

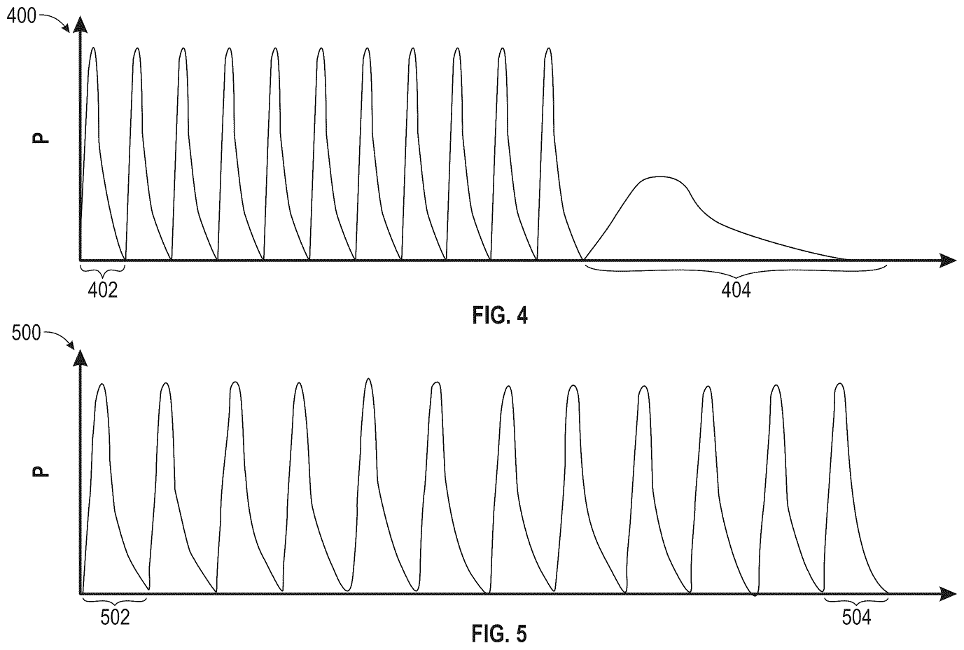

FIG. 4 shows a schematic graph indicating the impact of latency on Internet traffic. The graph 400 comprises low-latency regions 402 and high-latency region 404, wherein each region depicts a probability density function (pdf) of latency. Illustratively, the low-latency region 402 is associated with a fiber link, and the high-latency region 404 is associated with an access network latency. Long-haul Internet traffic flow may be characterized by transport across various links from a source server to a destination computing device. While fiber links typically have low latency (in some examples, where latency is characterized by router scheduling delay rather than propagation delay), access network latency tends to be much higher as the access network is often a bottleneck due to, for example, limited capacity. The combined pdf of the latency across the long-haul path is given by a successive convolution operation of the individual pdfs across all the links. In some examples, latency, and consequently a rebuffering rate, may be reduced by utilizing a content delivery network (CDN). In a CDN, content is cached physically closer to subscribers, turning the long-haul path into a short-haul path (i.e., reducing the number of links between a source server and the access network). In this example, the content may lie outside or inside an ISP network (for example, Netflix open connect appliances (OCA) and/or streaming video technology alliance (SVTA) open caching). Utilizing a CDN may require caching infrastructure to reduce the latency and/or rebuffering rate.

FIG. 5 shows another schematic graph indicating the impact of prioritization on latency for Internet traffic. The graph 500 comprises first and second low-latency regions 502 and 504. Typically, the first low-latency region 502 is associated with a fiber link, and the second low-latency region 504 is associated with an access network configured in accordance with one of the examples discussed herein. Through prioritization and/or treatment of a subset of Internet traffic being transmitted via the access network, the latency of the access network may be modified such that it more closely resembles a fiber link. Through prioritization of Internet traffic, the jitter on the access network may reduce, thereby reducing rebuffering. In this manner, the latency and/or rebuffering rate of long-haul Internet traffic may be reduced to resemble the latency and/or rebuffering rate of short-haul Internet traffic.

Internet traffic between a server and a computing device, such as a client computing device, may be identified as long-haul in one or more manners. In an example, an ISP may maintain a record and/or table of the location of different servers of video and/or web transport services. In this manner, a traffic flow identification module (such as the traffic flow identification module 212 of FIG. 2) at the upstream edge of the access network may perform a table lookup to determine whether a particular subscriber is requesting video and/or other services from a faraway server. In some examples, the traffic flow identification module may perform a ping and/or a traceroute to determine latency to source server and/or to another appliance (e.g., an upstream router in an ISP network and/or a router that is few hops downstream from the source server). The traffic flow identification module may then infer that the source server is at a faraway distance.

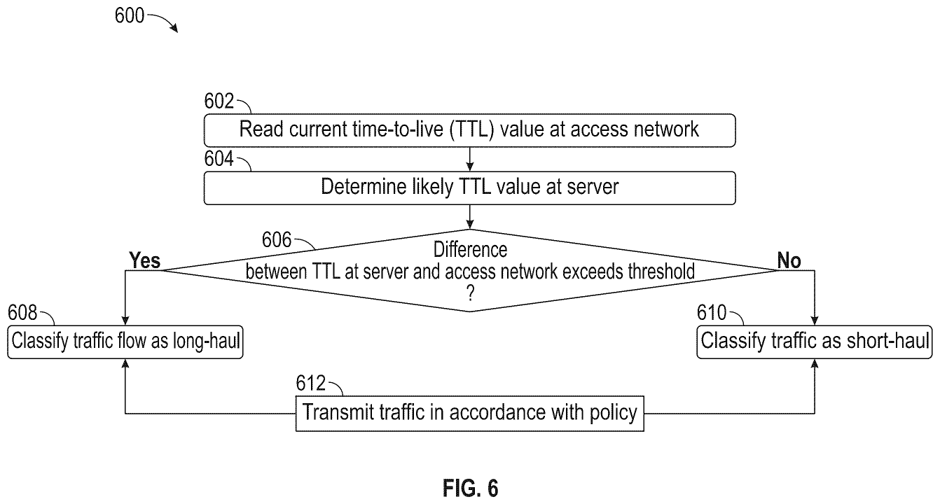

FIG. 6 shows another flowchart for reducing Internet traffic latency, in accordance with some embodiments of the disclosure. Process 600 may be implemented, in whole or in part, on any one or more of the computing devices mentioned herein. In addition, one or more actions of the process 600 may be incorporated into or combined with one or more actions of any other processes or embodiments and/or examples described herein.

FIG. 6 describes a TTL difference example for classifying Internet traffic as long-haul or short-haul. In this example, a current TTL value is read from an IP header of a packet belonging to a flow of Internet traffic. The likely TTL value at a source server is also estimated. The difference between the estimated TTL value at the source server and the current TTL value indicates the number of hops that the packet has travelled to reach the upstream edge of the access network. TTL is decremented by each (Layer 3) router along the path from source to destination, which enables an estimation of the TTL value at the source server to be made. Common default TTL values are 64, 128, or 255, and may be set for different operating systems, as for example:
Linux kernel 2.4 (circa 2001): 255 for TCP, user datagram protocol (UDP) and Internet control messaging protocol (ICMP);
Linux kernel 4.10 (2015 ): 64 for TCP, UDP and ICMP;
Windows XP (2001): 128 for TCP, UDP and ICMP;
Windows 10 (2015): 128 for TCP, UDP and ICMP;
Windows Server 2008: 128 for TCP, UDP and ICMP;
Windows Server 2019 (2018): 128 for TCP, UDP and ICMP; and
MacOS (2001): 64 for TCP, UDP and ICMP
   The TTL field in IPv4 has been replaced by the hop limit field in IPv6. The examples described herein may also be applied to the IPv6 hop limit field.

At 602, a current TTL value is read at an access network. For example, a current TTL in an IP header may be read. At 604, a likely TTL value at a server is determined. For example, this may be a likely IP header TTL at a source or streaming server. This likely TTL value may be determined via, for example, IP geolocation, metadata associated with the Internet traffic, and/or a historic value from a lookup table. At 606, it is determined whether a difference between the TTL at the server and the access network exceeds a threshold value. For example, it is determined whether the difference between the IP header TTL at the source server and an access network edge exceeds the threshold value. If, at 606, it is determined that the threshold value is exceeded, then the process proceeds to 608, where the traffic is classified as long-haul. The process then proceeds to step 612. If, at 606, it is determined that the threshold value is not exceeded, then the process proceeds to 610, where the traffic is classified as short-haul. The process then proceeds to step 612 where the traffic is transmitted in accordance with a long-haul or short-haul policy depending on whether the traffic is classified as long-haul or short-haul, respectively.

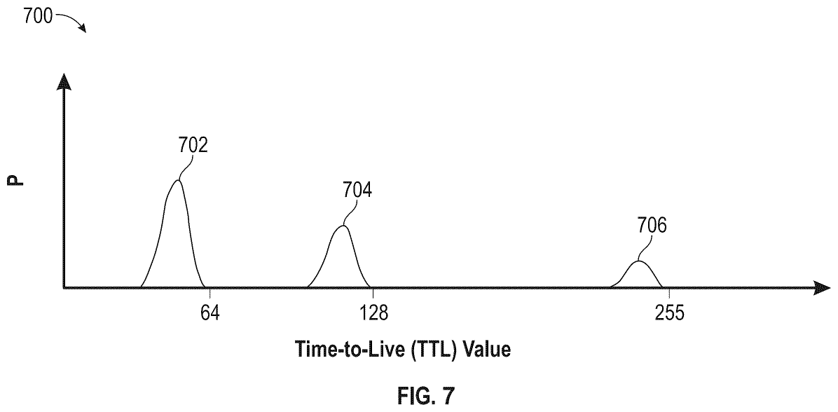

FIG. 7 shows another schematic graph indicating the impact of latency on Internet traffic. The graph 700 shows a distribution of TTL values, with a largest peak 702 occurring around a value of 64, a smaller peak 704 occurring around a value of 128 and a smallest peak 706 occurring around a value of 255.

With reference to the aforementioned common default TTL values, given that initial values of TTL are either 64, 128 or 255, FIG. 7 shows a trimodal distribution of probability of receiving a TTL value when read from an IP packet header. Typically, packets arrive at most destinations after no more than 10-15 hops. The higher peak of the probability distribution for values closely preceding 64 may be explained by the dominance of Linux in the server market. The intersection probability P (original TTL value and currently read TTL value) may also be characterized. The characterized P value may be used to estimate an original TTL value, i.e., P (original TTL value | currently read TTL value), for example, a TTL value of 70 points to an original TTL estimate of 64. A TTL value of 137 yields a higher probability that the estimate is 128, rather than 64. In some examples, an artificial intelligence and/or a machine learning model may be utilized for TTL prediction after data collection.

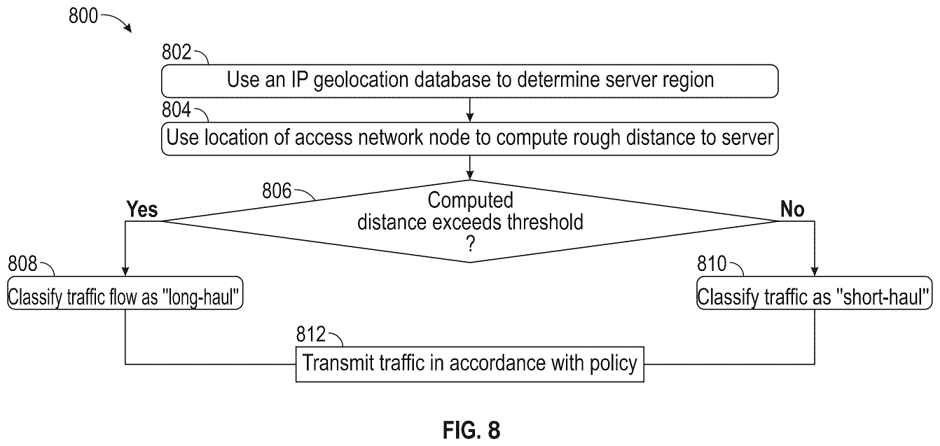

FIG. 8 shows another flowchart for reducing Internet traffic latency, in accordance with some embodiments of the disclosure. Process 800 may be implemented, in whole or in part, on any one or more of the computing devices mentioned herein. In addition, one or more actions of the process 800 may be incorporated into or combined with one or more actions of any other processes or embodiments and/or examples described herein.

At 802, an IP geolocation database is used to determine a server region. For example, the server may be a source or a streaming server. At 804, a location of an access network node is used to compute a rough distance to the server. For example, a known and/or configured location of the access network may be used to compute a rough distance to the server. In some examples, a straight-line distance may be used. In other examples, network topology, such as peering points between a carrier and Internet service provider (ISP) network may be used. In further examples, boarder gateway protocol (BGP) router configurations may be used if available. At 806, it is determined whether the computed distance exceeds a distance threshold. If, at 806, it is determined that the distance threshold is exceeded, then the process proceeds to 808, where the traffic is classified as long-haul. The process then proceeds to step 812. If, at 806, it is determined that the distance threshold is not exceeded, then the process proceeds to 810, where the traffic is classified as short-haul. The process then proceeds to step 812 where the traffic is transmitted in accordance with a long-haul or short-haul policy depending on whether the traffic is classified as long-haul or short-haul, respectively.

FIG. 8 illustrates a geolocation example for the identification of long-haul Internet traffic, where an IP geolocation database is utilized to determine a source server region and/or location. A traffic flow identification module (such as the traffic flow identification module 212 of FIG. 2) may be configured with a location, and the module may perform a computation to determine a distance to the source server. In some examples, a straight-line distance may be utilized to compute this distance, for example, when fiber density is high. In other examples, specific topology knowledge, such as a peering and/or meeting point between a carrier and an ISP network and/or a configuration of a BGP router (e.g., whether a certain path is allowed and/or forced) may be used to determine the distance. The computed distance is then used to determine whether the source server is far away, and therefore whether the traffic is long-haul. In some examples, TTL difference, geolocation, ping and/traceroute may be used in combination with each other. For example, geolocation may be used to identify the location of a server that originates real-time traffic. Subsequently, an estimate of an original TTL value is made based on the server location. This may then be utilized to calculate the number of hops the packets traversed.

An ISP may direct long-haul traffic of a certain class of applications to a low latency service flow, as described herein. In some examples, the ISP may change ECN markings used to denote L4S/low latency traffic flow. In other examples, the ISP may not change ECN markings used to denote L4S/low latency traffic flow. In some examples, when an ISP places packets into a low-latency queue as described herein, the ISP may modify a queue protection mechanism (or temporarily turn it off) so that a different threshold is applied to flow-associated timers for application traffic, thereby altering its qualification as a queue-building flow.

In some examples, when media delivery is set up via MOQT, metadata is embedded by an origin (contribution) server that indicates the location and/or region of the server. This metadata may be available for inspection at MOQT relays. An access network node may be co-located with an MOQT relay and/or may be configured to query an upstream MOQT relay to understand the point of origin (e.g., the origin server) and infer whether the traffic is long-haul and/or what application class/category the traffic flow belongs to.

In other examples, a traffic flow type other than, or in addition to, video, such as an interactive session, is identified. For example, chat applications use two-way interactivity, and the upstream direction is utilized to send input to the chat server from a client computing device. Similarly, an Internet protocol television (IPTV) middleware may be configured to provide an interactive guide for selecting a television program. Navigation and selection inputs associated with the interactive guide may be transmitted upstream to a server. In such cases, if the identified traffic flow is determined to belong to a class of applications that may benefit from low latency service flow in the upstream direction, then the upstream traffic is classified as long-haul and prioritization may be applied to the upstream traffic flow (and, in some examples, also to the downstream traffic to enable faster rendering of the input at the client computing device) by shifting the traffic to a low latency service flow in the upstream direction (or, in some examples, in both the upstream and downstream directions).

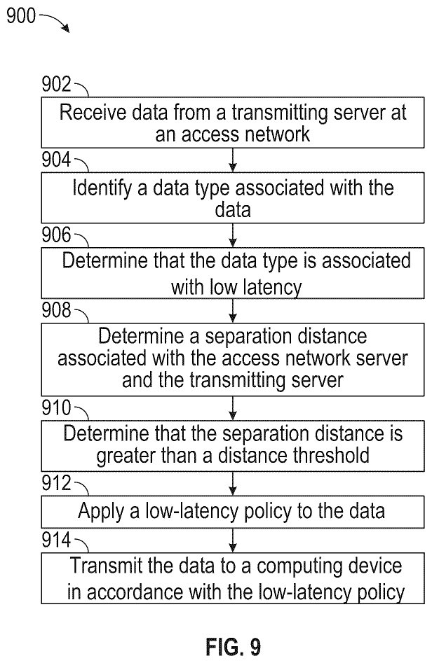

FIG. 9 shows a flowchart of illustrative steps for reducing Internet traffic latency, in accordance with some embodiments of the disclosure. Process 900 may be implemented, in whole or in part, on any one or more of the computing devices mentioned herein. In addition, one or more actions of the process 900 may be incorporated into or combined with one or more actions of any other processes or embodiments and/or examples described herein.

At 902, data from a transmitting server is received at an access network, and, at 904, a data type associated with the data is identified. At 906, it is determined that the data type is associated with low latency, and, based on, at least in part, the determining that the data type is associated with low latency, at 908, a separation distance associated with the access network server and the transmitting server is determined. At 910, it is determined that the separation distance is greater than a distance threshold, and, at 912, a low-latency policy is applied to the data. At 914, the data is transmitted to a computing device in accordance with the low-latency policy.

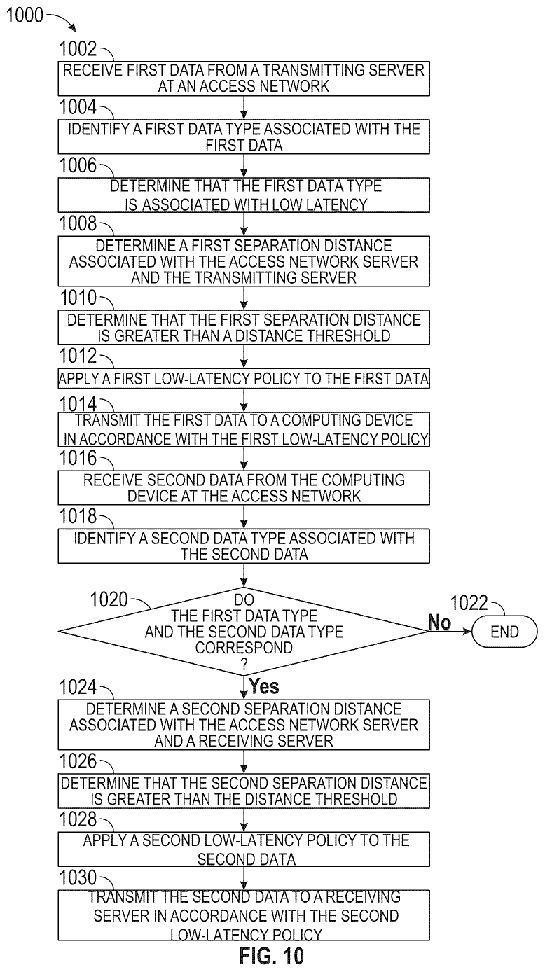

FIG. 10 shows another flowchart of illustrative steps for reducing Internet traffic latency, in accordance with some embodiments of the disclosure. Process 1000 may be implemented, in whole or in part, on any one or more of the computing devices mentioned herein. In addition, one or more actions of the process 1000 may be incorporated into or combined with one or more actions of any other processes or embodiments and/or examples described herein.

At 1002, first data from a transmitting server is received at an access network, and, at 1004, a first data type associated with the first data is identified. At 1006, it is determined that the first data type is associated with low latency, and, based on, at least in part, the determining that the data type is associated with low latency, at 1008, a first separation distance associated with the access network server and the transmitting server is determined. At 1010, it is determined that the separation distance is greater than a distance threshold, and, at 1012, a first low-latency policy is applied to the first data. At 1014, the first data is transmitted to a computing device in accordance with the first low-latency policy.

At 1016, second data is received from the computing device at the access network, and, at 1018, a second data type associated with the second data is identified. At 1020, it is determined whether the first data type and the second data type correspond. Corresponding data types may be, for example, data that comes from different applications but relates to, for example, VOIP, video and/or gaming. This determination may be performed via, for example, a trained machine learning model and/or a trained artificial intelligence model. A first data type and a second data type may correspond if they belong to the same flow, i.e., using the 5-tuple (Source IP address, Source port, Dest. IP address, Dest. Port, Protocol). In opposite traffic flow directions, the source and destination addresses and/or ports may be swapped. If, at 1020, it is determined that the first data type and the second data type do not correspond, then the process proceeds to 1022, where it ends and the data continues to be transferred in a default manner, for example, in a low priority, non-low latency and/or as otherwise specified. If, at 1020, it is determined that the first data type and the second data type correspond, then the process proceeds to 1024, where a second separation distance associated with the access network server and a receiving server is determined. At 1026, it is determined that the second separation distance is greater than the distance threshold, and, at 1028, a second low-latency policy is applied to the second data. At 1030, the second data is transmitted to the receiving server in accordance with the second low-latency policy.

In some examples, if the data of the second type is being transmitted to the same server from which the data was received (for example, determined by the same IP address being utilized), then it may be assumed that the second separation distance is greater than the threshold distance, without an explicit determination being required.

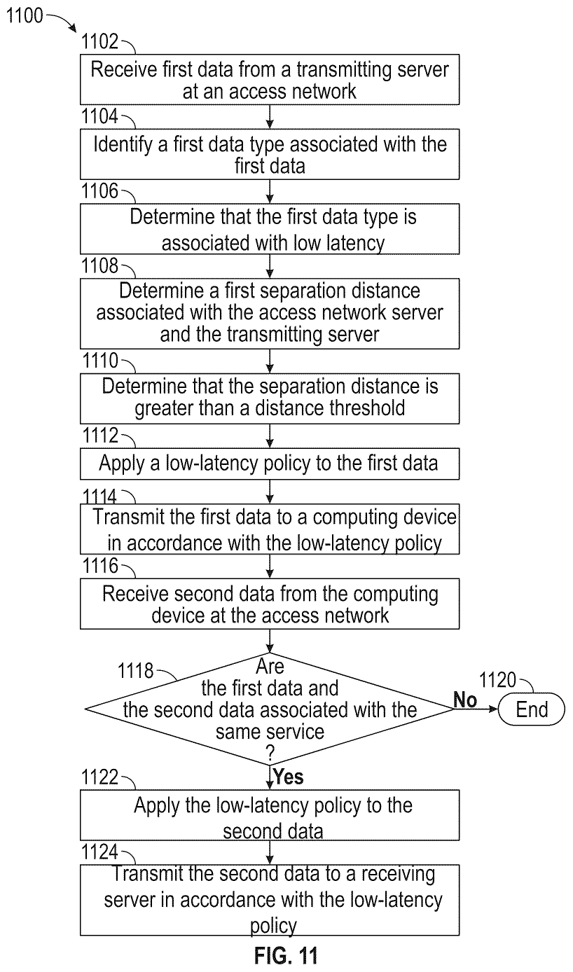

FIG. 11 shows another flowchart of illustrative steps for reducing Internet traffic latency, in accordance with some embodiments of the disclosure. Process 1100 may be implemented, in whole or in part, on any of the computing devices mentioned herein. In addition, one or more actions of the process 1100 may be incorporated into or combined with one or more actions of any other processes or embodiments and/or examples described herein.

At 1102, first data from a transmitting server is received at an access network, and, at 1104, a first data type associated with the first data is identified. At 1106, it is determined that the first data type is associated with low latency, and, based on, at least in part, the determining that the data type is associated with low latency, at 1108, a first separation distance associated with the access network server and the transmitting server is determined. At 1110, it is determined that the separation distance is greater than a distance threshold, and, at 1112, a low-latency policy is applied to the first data. At 1114, the first data is transmitted to a computing device in accordance with the low-latency policy.

At 1116, second data is received from the computing device at the access network, and, at 1118, it is determined whether the first data type and the second data type are associated with the same service. If, at 1118, it is determined that the first data type and the second data type are not associated with the same service, then the process proceeds to 1120, where it ends. If, 1118, it is determined that the first data type and the second data type are associated with the same service, then the process proceeds to 1122, where the low-latency policy is applied to the second data. At 1124, the second data is transmitted to the receiving server in accordance with the low-latency policy.

Internet traffic flow may be identified by the 5-tuple (IP address (source, destination), protocol and port (source, destination)). Video traffic typically flows downstream from a server a client computing device, and therefore is typically unidirectional; however, unidirectional traffic flows may be paired together for bidirectional flows (e.g., WebSockets and/or WebTransport) by observing IP addresses and port numbers associated with the traffic, which are switched for opposite directions (i.e., a source direction and a destination direction). Once long-haul traffic from a server to a client has been identified, it may be accelerated in both directions using this pairing.

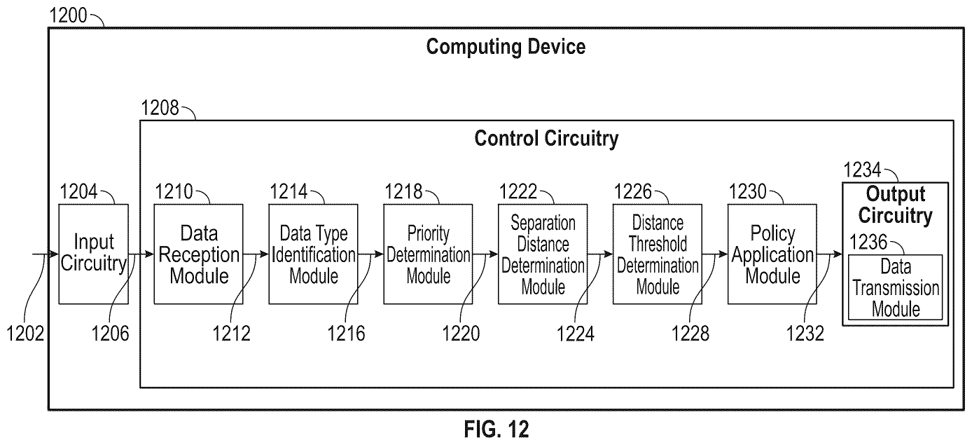

FIG. 12 shows a block diagram representing components of a computing device and dataflow therebetween for reducing Internet traffic latency, in accordance with some embodiments of the disclosure. Computing device 1200 comprises input circuitry 1204, control circuitry 1208 and output circuitry 1234. In this example, the computing device 1200 is an access network server. Control circuitry 1208 may be based on any suitable processing circuitry (not shown) and comprises control circuits and memory circuits, which may be disposed on a single integrated circuit or may be discrete components and processing circuitry. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i9 processors) or multiple different processors (e.g., an Intel Core i5 processor and an Intel Core i7 processor) and/or a system on a chip (e.g., a Qualcomm Snapdragon 8 processor). Some control circuits may be implemented in hardware, firmware, or software.

First input is received 1202 by the input circuitry 1204. The input circuitry 1204 is configured to receive inputs related to a computing device. For example, this input may be network traffic from a streaming server. In some examples, this input may be received via a keyboard and a mouse. In other examples, the input may be received via a touchscreen, an infrared controller, a Bluetooth and/or Wi-Fi controller of the computing device 1200, and/or a microphone. In some examples, this may be via a gesture detected via an extended reality device. In a further example, the input may comprise instructions received via another computing device. The input circuitry 1204 transmits 1206 the user input to the control circuitry 1208.

The control circuitry 1208 comprises a data reception module 1210, a data type identification module 1214, a priority determination module 1218, a separation distance determination module 1222, a distance threshold determination module 1226, a policy application module 1230 and output circuitry 1234 comprising a data transmission module 1236.

The first input is transmitted 1206 to the data reception module 1210, where data is received from a transmitting server. The data is transmitted 1212 to the data type identification module 1214, where a data type associated with the data is identified. An indication of the data type is transmitted 1216 to the priority determination module 1218, where it is determined whether the data type is associated with low latency. For data associated with low latency, an indication is transmitted 1220 to the separation distance determination module 1222, where a separation distance associated with the access network server and the transmitting server is determined. An indication of the separation distance is transmitted 1224 to the distance threshold determination module 1226, where it is determined whether the separation distance is greater than a threshold distance. If the distance is greater than the distance threshold, an indication is transmitted 1228 to the policy application module 1230, where a low-latency policy is applied to the data. The data is transmitted 1232 to the output circuitry 1234 comprising the data transmission module 1236, where the data is transmitted from the access network server to a computing device (not shown) in accordance with the low-latency policy.

It is to be understood that various terms relating to latency may be understood as set forth in the following. These latency terms are not intended to be limiting but illustrative. “High” latency is, e.g., about 45 seconds or more. An example of this is dynamic adaptive streaming over HTTP (DASH) and/or HTTP live streaming (HLS) with 10-second segments. “Typical” latency ranges, e.g., from about 10 to about 45 seconds. This can be seen in DASH and/or HLS with 6-second segments. DASH and/or HLS with 2-second segments falls between low latency and typical latency. “Low” latency is, e.g., between about 1 and 10 seconds. Examples include DASH and/or HLS with fragmented or 1-second segments, cable, IPTV, satellite, over-the-air broadcast, social media, messaging, live sports, game streaming, and eSports. Online gambling, betting, and auctioning fall between ultra-low latency and low latency. “Ultra-low” latency is, e.g., about 100 milliseconds to about 1 second. Cloud gaming, videoconferencing, and VOIP straddle the line between near-real-time latency and ultra-low latency. “Near-real-time” latency is, e.g., less than about 100 milliseconds. An example of this is surgical robots. Other examples include different game genres. For example, for a role playing fantasy game, a latency of less than about 100 milliseconds is likely sufficient. Whereas, in a first-person shooter game, end-to-end latency below about 40 milliseconds is desirable. In another example, virtual reality cloud gaming pushes these latencies even lower to below about 20 milliseconds.

The processes described above are intended to be illustrative and not limiting. One skilled in the art would appreciate that the steps of the processes discussed herein may be omitted, modified, combined, and/or rearranged, and any additional steps may be performed without departing from the scope of the disclosure. More generally, the above disclosure is meant to be illustrative and not limiting. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving, at an access network server, data from a transmitting server;
identifying, at the access network server, a data type associated with the data;
determining, at the access network server, that the data type is associated with low latency;
based on, at least in part, the determining that the data type is associated with low latency, determining, at the access network server, a separation distance associated with the access network server and the transmitting server;
determining, at the access network server, that the separation distance is greater than a distance threshold;
applying a low-latency policy to the data; and
transmitting the data, from the access network server, to a computing device in accordance with the low-latency policy.

2. The method of claim 1, wherein:
the receiving the data from the transmitting server further comprises receiving the data via Media-Over QUIC transport; and
the determining the separation distance associated with the access network server and the transmitting server further comprises accessing metadata associated with the data, wherein the metadata indicates a location of the transmitting server.

3. The method of claim 1, wherein the data is first data, the data type is a first data type, the separation distance is a first separation distance, the low-latency policy is a first low-latency policy and the method further comprises:
receiving, at the access network server, second data from the computing device;
identifying, at the access network server, a second data type associated with the second data;
determining, at the access network server, that the first data type and the second data type correspond;
determining, at the access network server, a second separation distance associated with the access network server and a receiving server;
determining, at the access network server, that the second separation distance is greater than the distance threshold;
applying a second low-latency policy to the second data; and
transmitting the second data, from the access network server, to the receiving server in accordance with the second low-latency policy.

4. The method of claim 1, wherein the data is first data and the method further comprises:
receiving, at the access network server, second data from the computing device;
determining, at the access network server, that the first data and the second data are associated with the same service;
applying the low-latency policy to the second data; and
transmitting the second data, from the access network server, to a receiving server in accordance with the low-latency policy.

5. The method of claim 1, wherein the identifying the data type associated with the data comprises identifying an explicit congestion notification bit associated with the data.

6. The method of claim 1, wherein the transmitting the data in accordance with the low-latency policy further comprises transmitting the data via a low latency service flow and/or a quality of service flow.

7. The method of claim 1, wherein the determining the separation distance associated with the access network server and the transmitting server comprises determining the separation distance via a lookup table.

8. The method of claim 1, wherein the determining the separation distance associated with the access network server and the transmitting server comprises determining the separation distance via a ping to the transmitting server.

9. The method of claim 1, wherein:
the determining the separation distance associated with the access network server and the transmitting server comprises:
identifying a first time-to-live value associated with the data;
estimating a second time-to-live value associated with the transmitting server; and
determining a difference between the second time-to-live value and the first time-to-live value; and
the determining that the separation distance is greater than the distance threshold comprises determining that the difference between the second time-to-live value and the first time-to-live value is greater than a difference threshold.

10. The method of claim 1, wherein the determining the separation distance associated with the access network server and the transmitting server comprises:
receiving, from a geolocation database, a geographic location associated with the transmitting server; and
computing a distance between the access network server and the geographic location associated with the transmitting server.

11. A system comprising:
input/output circuitry configured to:
receive, at an access network server, data from a transmitting server; and
processing circuitry configured to:
identify, at the access network server, a data type associated with the data;
determine, at the access network server, that the data type is associated with low latency;
based on, at least in part, the determining that the data type is associated with low latency, determine, at the access network server, a separation distance associated with the access network server and the transmitting server;
determine, at the access network server, that the separation distance is greater than a distance threshold;
apply a low-latency policy to the data; and
transmit the data, from the access network server, to a computing device in accordance with the low-latency policy.

12. The system of claim 11, wherein:
the processing circuitry configured to receive the data from the transmitting server is further configured to receive the data via Media-Over QUIC transport; and
the processing circuitry configured to determine the separation distance associated with the access network server and the transmitting server is further configured to access metadata associated with the data, wherein the metadata indicates a location of the transmitting server.

13. The system of claim 11, wherein the data is first data, the data type is a first data type, the separation distance is a first separation distance, the low-latency policy is a first low-latency policy and the processing circuitry is further configured to:
receive, at the access network server, second data from the computing device;
identify, at the access network server, a second data type associated with the second data;
determine, at the access network server, that the first data type and the second data type correspond;
determine, at the access network server, a second separation distance associated with the access network server and a receiving server;
determine, at the access network server, that the second separation distance is greater than the distance threshold;
apply a second low-latency policy to the second data; and
transmit the second data, from the access network server, to the receiving server in accordance with the second low-latency policy.

14. The system of claim 11, wherein the data is first data and the processing circuitry is further configured to:
receive, at the access network server, second data from the computing device;
determine, at the access network server, that the first data and the second data are associated with the same service;
apply the low-latency policy to the second data; and
transmit the second data, from the access network server, to a receiving server in accordance with the low-latency policy.

15. The system of claim 11, wherein the processing circuitry configured to identify the data type associated with the data is configured to identify an explicit congestion notification bit associated with the data.

16. The system of claim 11, wherein the processing circuitry configured to transmit the data in accordance with the low-latency policy is further configured to transmit the data via a low latency service flow and/or a quality of service flow.

17. The system of claim 11, wherein the processing circuitry configured to determine the separation distance associated with the access network server and the transmitting server is configured to determine the separation distance via a lookup table.

18. The system of claim 11, wherein the processing circuitry configured to determine the separation distance associated with the access network server and the transmitting server is configured to determine the separation distance via a ping to the transmitting server.

19. The system of claim 11, wherein:
the processing circuitry configured to determine the separation distance associated with the access network server and the transmitting server is configured to:
identify a first time-to-live value associated with the data;
estimate a second time-to-live value associated with the transmitting server; and
determine a difference between the second time-to-live value and the first time-to-live value; and
the processing circuitry configured to determine that the separation distance is greater than the distance threshold is configured to determine that the difference between the second time-to-live value and the first time-to-live value is greater than a difference threshold.

20. The system of claim 11, wherein the processing circuitry configured to determine the separation distance associated with the access network server and the transmitting server is configured to:
receive, from a geolocation database, a geographic location associated with the transmitting server; and
compute a distance between the access network server and the geographic location associated with the transmitting server.

21-50. (canceled)
